(19) United States
(12) Patent Application Publication
(10) Pub. No.: US 2023/0294192 A1
(43) Pub. Date: Sep. 21, 2023

(54) SYSTEM AND METHOD FOR AUTOMATING SUBSEQUENT PASSES OF A WELDING OPERATION

(71) Applicant: Novarc Technologies Inc., North Vancouver (CA)

(72) Inventors: Ahmad ASHOORI, North Vancouver (CA); Ringo GONZALEZ, North Vancouver (CA); Daniel HARVEY, North Vancouver (CA); Souroush KARIMZADEH, North Vancouver (CA)

(21) Appl. No.: 18/186,577

(22) Filed: Mar. 20, 2023

Related U.S. Application Data
(60) Provisional application No. 63/321,327, filed on Mar. 18, 2022.

(51) Int. Cl. B23K 9/095; B25J 11/00; B23K 9/028

(52) U.S. Cl. CPC B23K 9/0953; B25J 11/005; B23K 9/0282; B23K 9/0956; B23K 2101/06

(57) ABSTRACT

Disclosed is a system having a robotic welding apparatus configured to weld metal sections together along a seam, an input device configured to produce positioning input for the robotic welding apparatus while welding, and a controller configured to control the robotic welding apparatus in accordance with (i) a recording state in which operation of the robotic welding apparatus is controlled and recorded while welding in a root pass based on the positioning input to produce recorded positioning data, and (ii) an automatic state in which operation of the robotic welding apparatus is automatically controlled while welding in a subsequent pass based on the recorded positioning data. In accordance with an embodiment, motion of the robotic welding apparatus is selectively recorded such that the recorded positioning data utilized in the automatic state omits (i) initial transient motions of the robotic welding apparatus and/or (ii) stop-start motions of the robotic welding apparatus.

### RELATED APPLICATION

This patent application claims priority from U.S. Provisional Application No. 63/321,327 filed on Mar. 18, 2022, the entire disclosure of which is incorporated by reference.

### FIELD OF THE DISCLOSURE

This disclosure relates to welding systems, and more particularly to robotic welding apparatuses that perform automatic welding.

### BACKGROUND

Robotic welding apparatuses that perform automatic welding are known in the art. See for example PCT publication WO 2019/153090, which discloses a method for controlling a robotic welding apparatus to weld pipe sections together. In that disclosure, the pipe sections are held in fixed relation to each other by a plurality of stitches at a seam between the pipe sections, and the robotic welding apparatus operates to weld the pipe sections together.

When welding two metal sections together, such as pipe sections, it is commonplace to have multiple passes. A first pass is generally referred to a root pass and sets out to weld the two metal sections into one structure, albeit with a weld depth that may not be very thick. Subsequent passes can increase the weld depth to a desired thickness, thereby increasing strength. There may be multiple subsequent passes depending on the two metal sections and the desired thickness of the weld depth.

It can be difficult and/or time consuming to manually perform the first pass and the subsequent passes of the welding process. Some existing approaches attempt to automate some aspects of the welding process, but they leave much to be desired in terms of welding quality. It is desirable to provide a system and a method to automate some or all of the welding process in a manner that can improve upon welding quality.

### SUMMARY OF THE DISCLOSURE

Disclosed is a system having a robotic welding apparatus configured to weld metal sections together along a seam, an input device configured to produce positioning input for the robotic welding apparatus while welding, and a controller configured to control the robotic welding apparatus in accordance with (i) a recording state in which operation of the robotic welding apparatus is controlled and recorded while welding in a root pass based on the positioning input to produce recorded positioning data, and (ii) an automatic state in which operation of the robotic welding apparatus is automatically controlled while welding in a subsequent pass based on the recorded positioning data.

In accordance with an embodiment of the disclosure, motion of the robotic welding apparatus is selectively recorded such that the recorded positioning data utilized in the automatic state omits (i) initial transient motions of the robotic welding apparatus and/or (ii) stop-start motions of the robotic welding apparatus. By omitting (i) initial transient motions of the robotic welding apparatus and/or (ii) stop-start motions of the robotic welding apparatus during the root pass, the recorded positioning data can be used for enabling automatic operation of the robotic welding apparatus during at least one and up to all of the subsequent passes in a way that avoids problems associated with the initial transient motions and/or stop-start motions of the robotic welding apparatus. This can improve upon welding quality.

Also disclosed is a method comprising: welding, using a robotic welding apparatus, metal sections together along a seam in a root pass in accordance with a recording state in which operation of the robotic welding apparatus is controlled and recorded based on positioning input from an input device to produce recorded positioning data; welding, using a robotic welding apparatus, the metal sections together along the seam in a subsequent pass in accordance with an automatic state in which operation of the robotic welding apparatus is automatically controlled based on the recorded positioning data; wherein the method comprises selectively recording motion of the robotic welding apparatus such that the recorded positioning data utilized in the automatic state omits (i) initial transient motions of the robotic welding apparatus and/or (ii) stop-start motions of the robotic welding apparatus.

Also disclosed is a non-transitory computer readable medium having recorded thereon statements and instructions that, when executed by control circuitry of a welding system, configure the welding system to implement the method summarized above.

Other aspects and features of the present disclosure will become apparent, to those ordinarily skilled in the art, upon review of the following description of the various embodiments of the disclosure.

### BRIEF DESCRIPTION OF THE DRAWINGS

Embodiments will now be described with reference to the attached drawings in which:

FIG. 1 is a photograph of pipe sections stitched together with stitches in preparation for welding;

FIG. 2 is a schematic of an example system having a robotic welding apparatus for welding the pipe sections together;

FIG. 3 is a block diagram of the system shown in FIG. 2;

FIGS. 4 and 5 are photographs of the pipe sections in varying angular orientations for welding;

FIGS. 6 and 7 are schematics indicating periodic positioning of the robotic welding apparatus during multiple passes of welding;

FIGS. 8 and 9 are charts indicating actual positioning of the robotic welding apparatus versus recorded positioning; and

FIG. 10 is a flowchart of a method for welding metal sections together.

### DETAILED DESCRIPTION OF EMBODIMENTS

It should be understood at the outset that although illustrative implementations of one or more embodiments of the present disclosure are provided below, the disclosed systems and/or methods may be implemented using any number of techniques. The disclosure should in no way be limited to the illustrative implementations, drawings, and techniques illustrated below, including the exemplary designs and implementations illustrated and described herein, but may be modified within the scope of the appended claims along with their full scope of equivalents.

### Introduction & Welding System

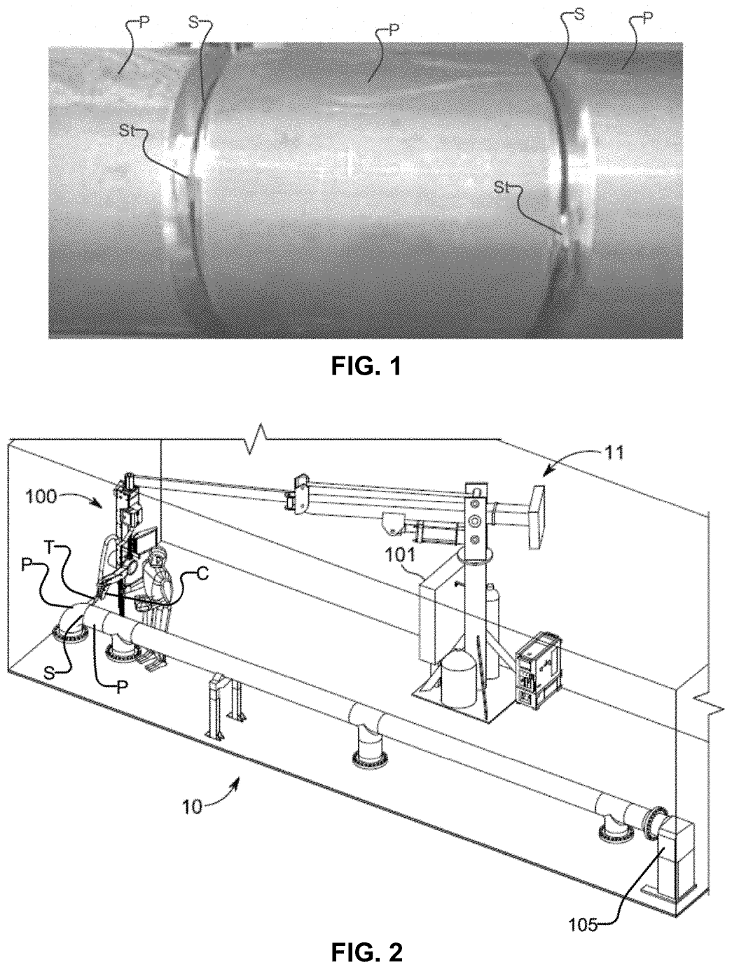

Referring first to FIG. 1, shown is a photograph of pipe sections P stitched together with stitches St in preparation for welding. A seam S is located at an interface between each pair of adjacent pipe sections P, and the stitches St are located around each seam S to hold the pipe sections P together to form a pipe string. For example, each seam S may have three stitches St spaced about a circumference of the pipe sections P. The three stitches St can be evenly spaced (e.g. separated by about 120°), or unevenly spaced. More or less than three stitches St can be used for each seam S depending on a diameter and a wall thickness of the pipe sections P.

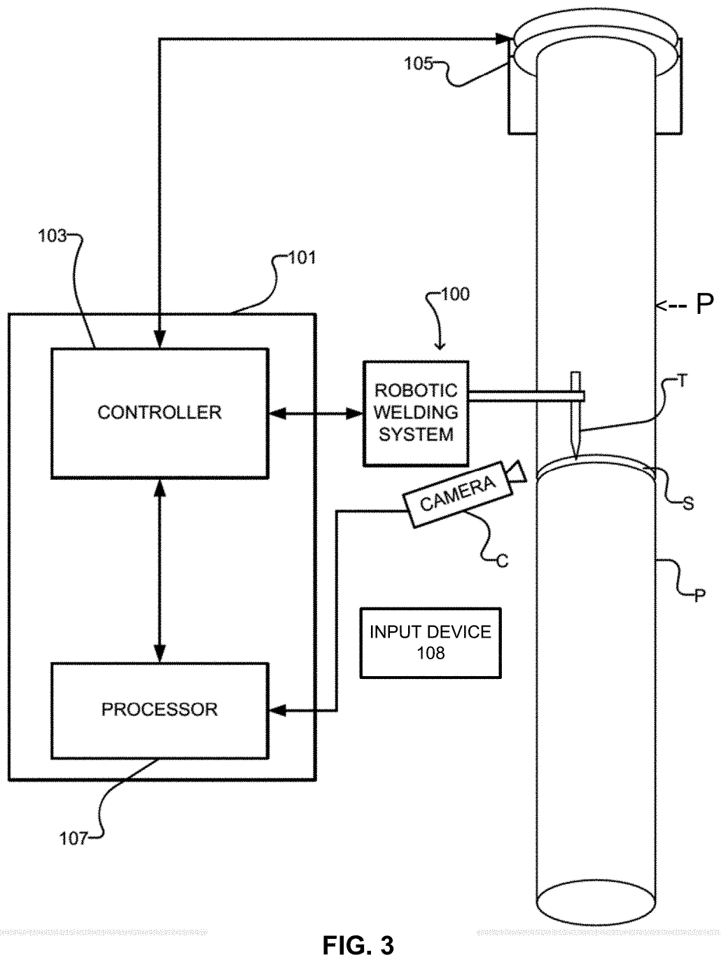

Referring now to FIG. 2, shown is an example system 10 having a robotic welding apparatus 100 for welding the pipe sections P together. The robotic welding apparatus 100 has a welding torch T for performing welding. In some implementations, the system 10 also includes a camera C for capturing frames of the welding, and a repositionable support structure 11 that facilitates positioning of the welding torch T at a seam S to be welded. In some implementations, the system 10 also includes a positioner 105, which rotates the pipe sections P in relation to the robotic welding apparatus 100 mounted on the repositionable support structure 11. In some implementations, the system 10 also includes a control cabinet 101, which is operably connected to the robotic welding apparatus 100 and the camera C.

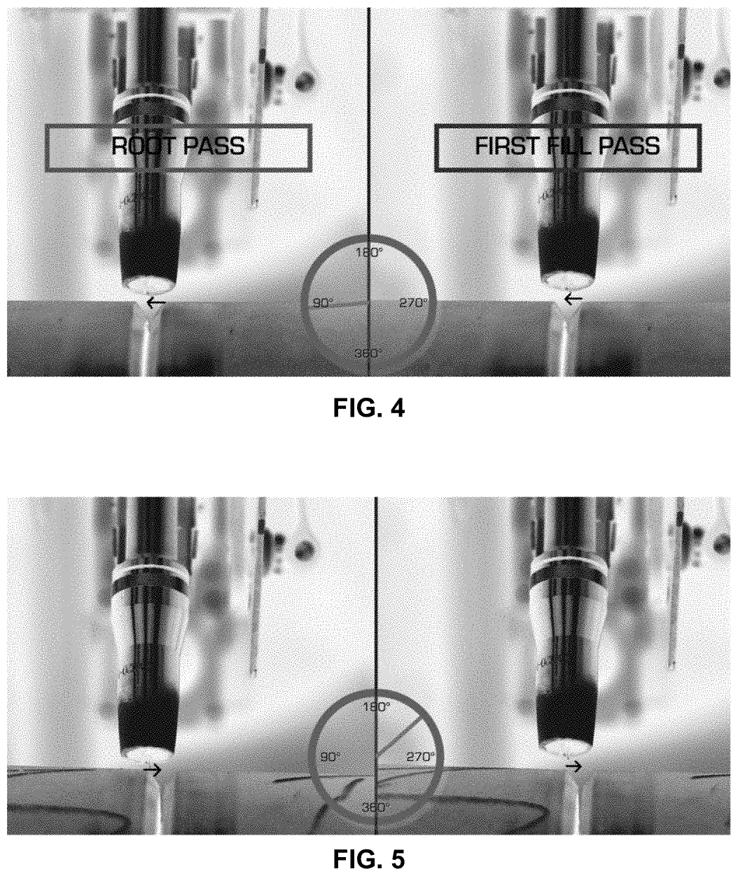

Referring now to FIG. 3, shown is a block diagram of the system 10 shown in FIG. 2. In some implementations, the control cabinet 101 houses a controller 103 for the robotic welding apparatus 100. In some implementations, the control cabinet 101 also houses a processor 107 connected to the camera C and the controller 103. In some implementations, the processor 107 is configured to process images from the camera C and to provide the controller 103 with signals based on processed images. More generally, the system 10 has at least one input device 108, which in the illustrated example comprises the camera C, although other input devices are possible, including a joystick device for use by an operator, a laser device, etc. The input device 108 is configured to produce positioning input for the robotic welding apparatus 100 while welding. In some implementations, the input device 108 is coupled directly to the controller 103 or indirectly to the controller 103 through the processor 107 as shown for the camera C.

The controller 103 is configured to control the robotic welding apparatus 100 to execute a welding pattern. In some implementations, the controller 103 also controls the positioner 105 to rotate the pipe sections P. The pipe sections P can be rotated while the robotic welding apparatus 100 operates to weld the pipe sections P together. During the welding, a first full rotation (i.e. 360°) corresponds to a root pass, and each subsequent full rotation (i.e. 360°) corresponds to a subsequent pass. The controller 103 is configured to control the robotic welding apparatus 100 in accordance with (i) a recording state in which operation of the robotic welding apparatus 100 is controlled and recorded while welding in a root pass based on the positioning input to produce recorded positioning data, and (ii) an automatic state in which operation of the robotic welding apparatus is automatically controlled while welding in a subsequent pass based on the recorded positioning data.

In accordance with an embodiment of the disclosure, motion of the robotic welding apparatus is selectively recorded such that the recorded positioning data utilized in the automatic state omits (i) initial transient motions of the robotic welding apparatus and/or (ii) stop-start motions of the robotic welding apparatus. By omitting (i) initial transient motions of the robotic welding apparatus and/or (ii) stop-start motions of the robotic welding apparatus during the root pass, the recorded positioning data can be used for enabling automatic operation of the robotic welding apparatus during the subsequent pass in a way that avoids problems associated with the initial transient motions and/or stop-start motions of the robotic welding apparatus. This can improve upon welding quality.

There are may possibilities for the recorded positioning data. The recorded positioning data can be any appropriate data series that captures positioning of the robotic welding apparatus 100 (e.g. lateral position of the welding torch T or arm, and/or angle of the welding torch T or arm, etc.) during the root pass. In some implementations, recorded positions of the welding apparatus 100 are paired with positions of the positioner 105. Thus, if in the subsequent passes the pipe P travels faster, no issues should happen according to the approach disclosed herein.

There are many ways in which the recorded positioning data can omit the initial transient motions of the robotic welding apparatus. In some implementations, the motions of the robotic welding apparatus are omitted for an initial time period at a beginning of the root pass. For example, recorded motions of the robotic welding apparatus during the initial time period can be removed prior to the subsequent passes. Alternatively, recording of the motions of the robotic welding apparatus can start after the initial time period. In some embodiments, the initial time period may be a predetermined time period. In some embodiments, the initial time period may be a programmable time period. In some embodiments, the initial time period may be adaptively determined by the controller based on the motions of the robotic welding apparatus.

There are many ways in which the recorded positioning data can omit stop-start motions of the robotic welding apparatus. In some implementations, the stop-start motions are responsive to a welding mishap (e.g. welding blow-through, etc.) and involves repeat welding in a region of the welding mishap, such that the recorded positioning data omits motions of the robotic welding apparatus during the welding mishap. For example, recorded motions of the robotic welding apparatus during the welding mishap can be removed prior to the subsequent passes, and replaced with recorded motions of the robotic welding apparatus during the repeat welding. Alternatively, depending on the type of welding mishap, recording of the motions of the robotic welding apparatus can be paused during the welding mishap.

Although the illustrated example shows the metal sections P as pipe sections P that have been stitched together with stitches St to form a pipe string, it is to be understood that other metal sections of varying shapes and sizes can be welded together. The disclosure is not limited to welding pipe sections P. Other metal sections such as flat metal sections can be welded together, for example. For such other implementations, there might be no positioner 105. Other mechanisms are possible for manipulating the metal sections P to be welded. Alternatively, the metal sections P are not manipulated at all, and the robotic welding apparatus 100 performs all of movement for the welding.

There are many possibilities for the controller 103 and the processor 107 of the system 10. In some implementations, the controller 103 includes a PLC (programmable logic controller). In some implementations, the processor includes a CPU (central processing unit), an IPC (industrial PC) and/or a GPU (graphics processing unit) using CUDA (Compute Unified Device Architecture) or other parallel computing platform. Other implementations can include additional or alternative hardware components, such as any appropriately configured FPGA (Field-Programmable Gate Array), ASIC (Application-Specific Integrated Circuit), and/or processor, for example. More generally, the system 10 can be controlled with any suitable control circuitry. The control circuitry can include any suitable combination of hardware, software and/or firmware.

Details of an example implementation for the robotic welding apparatus 100 can be found in PCT patent application publication no. WO 2019/153090 and PCT patent application publication no. WO 2017/165964, which are hereby incorporated by reference. Other implementations for the robotic welding apparatus 100 are possible and are within the scope of the disclosure.

### Further Details of Welding

Embodiments disclosed herein reproduce a profile of a seam axis (lateral movements of a welding arm) travelled on a root pass onto subsequent passes. Inputs of the seam axis on the root pass can be from laser inputs and/or operator inputs (e.g. with joystick). They all will be memorized according to positioner position. These movements will “smoothly” be repeated on the subsequent passes.

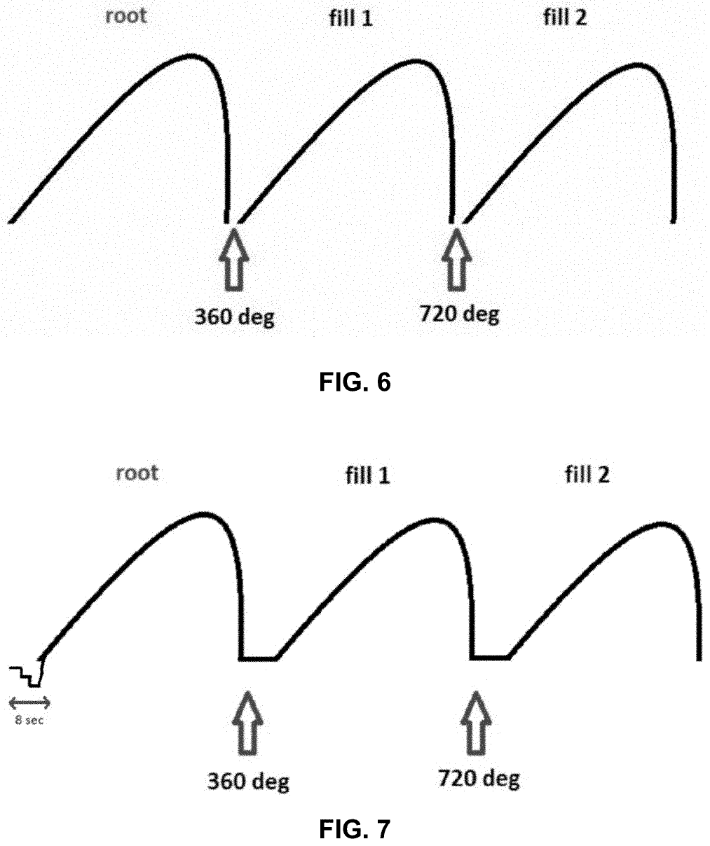

For example, with reference to FIG. 4, due to pipe being out of roundness, the welding torch T will get a little bit off center on the root pass, while the pipe rotates. This deviation will make the controller 103 to command the welding torch T to move left (see photo on the left). This movement will be memorized, so that on the second pass the same movement will be repeated by the controller 103 (see photo on the right).

As another example, with reference to FIG. 5, the pipe has actually deviated a lot and the welding torch T is quite off center (note that this is an exaggeration of the reality, because the controller 103 corrects in real-time and those large deviations won't be seen). Then, the operator on the root pass will correct the position of the welding torch T to the right (see photo on the left). This movement will be repeated by the controller 103 on subsequent passes (see photo on the right).

In both illustrated examples, a circle in the middle shows how much the pipe has rotated out of 360° revolution. Basically, movements on the first pass are tied into the pipe position (between 0° and 360°) and the same movements are going to be repeated at exact same positions on the second pass (between 0° and 360° or more mathematically speaking from 360° to 720°).

Although reference is made to the pipe being out of roundness as a cause for the welding torch T coming off center, it is noted that there could be other reasons as well. The pipe being out of round, poor fit-up of the pipe, and pipe being mounted on the chuck at an angle are the most common reasons for torch T to become off center.

Embodiments disclosed herein can enable more automation in subsequent passes, thereby moving to a direction of press a button and go. In some implementations, a root pass is performed either with operator guidance or automated (e.g. using camera or laser or Through Arc Seam Tracking aka TAST or etc.) and memorized. Subsequent passes identical to the memorized pass from a given starting point are performed. These subsequent passes are generally periodic because they match the root pass, but to some extent a subsequent pass may be considered to be non-periodic if an operator offset is added to the subsequent pass, for example using a joystick device.

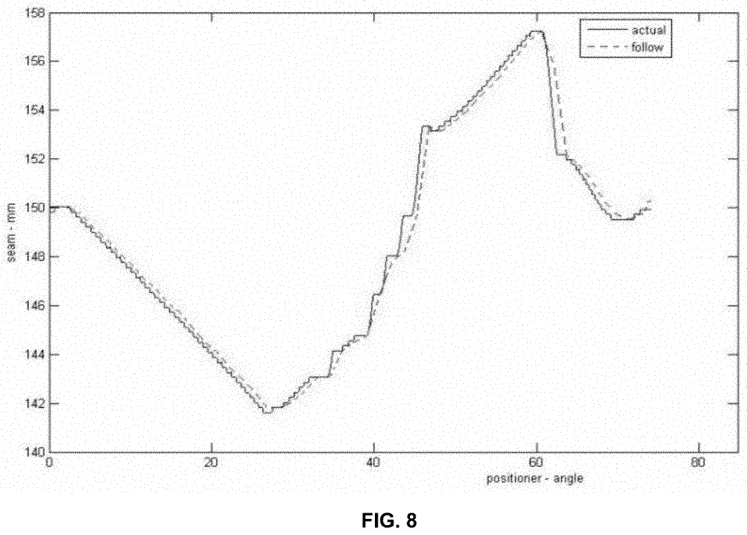

With reference to FIG. 6, a root pass is welded, with laser or camera or TAST inputs, or operator (joystick) inputs. In a pre-programmed multi-pass welding, once each pass finishes, the welding apparatus can be commanded to move up and maybe left/right depending on how pass configuration is built up according to weld fill requirements, which may sometimes referred to as a “recipe”, which depend on the type of joint between the metal sections to be welded together. The up movements are known as recipe vertical offsets. The left/right movements are known as recipe horizontal offsets. In the case of pass memorization, we want to repeat the first pass in subsequent passes not necessarily all on top of each other. So if the preferred recipe for the joint being welded includes a recipe horizontal offset directing that the welding apparatus should move left on the second pass, then the system is configured to cause the welding apparatus to repeat the recorded motions from the root pass, starting from that new lateral position, or in other words after the recipe offset. For each pass a new starting point is given based on encoder position calculations and any recipe offsets.

With reference to FIG. 7, it is possible to correct a start of the welding motion. In the example shown in FIG. 7, an initial time period of eight seconds of transient motion are omitted from a beginning of the root pass. In other examples a different length of initial time period may be omitted, depending on the length of the transient motions. If such transient motion were to be repeated in subsequent passes, welding quality may suffer. It is also possible to correct stop-starts (like blow-throughs), for example by replacing recorded motions leading up to a blow-through with recorded motions for the repeat welding, as discussed above. If motions that led to a blow-through is repeated in subsequent passes, welding quality may suffer.

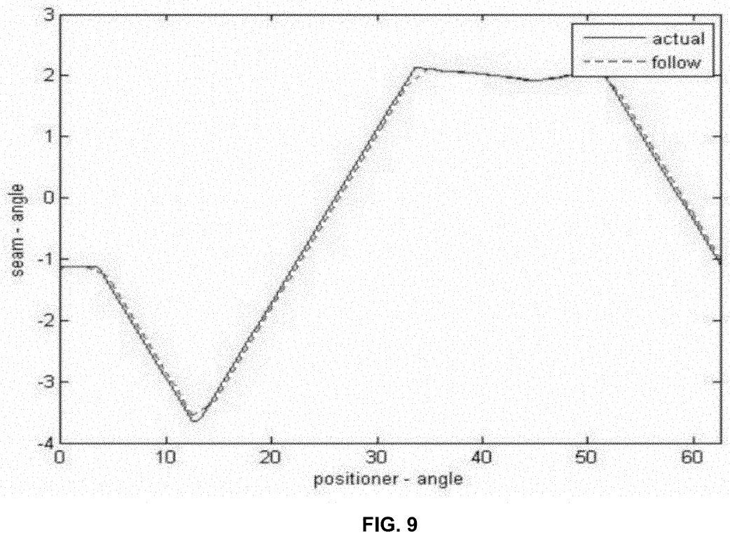

With reference to FIGS. 8 and 9, shown are charts indicating actual positioning of an example robotic welding apparatus versus recorded positioning. The actual positioning of the robotic welding apparatus tracks the recorded positioning reasonably well. Thus, the subsequent passes can mirror the root pass very closely.

### Method for Automatic Welding

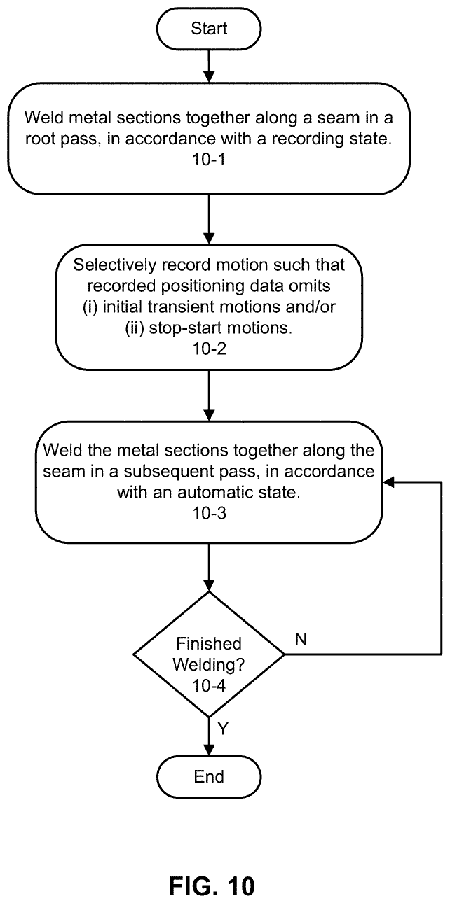

Referring now to FIG. 10, shown is a flowchart of a method for welding metal sections together. This method can be implemented by control circuitry of a welding system, for example by the controller 103 and/or the processor 107 of the system 10 shown in FIG. 3. More generally, this method can be implemented by any appropriate control circuitry, whether it be a combination of components or a single component.

At step 10-1, the control circuitry controls the welding system to weld metal sections together along a seam in a root pass, in accordance with a recording state. Examples of how this may be accomplished have been described above and are thus not repeated here.

At step 10-2, the control circuitry controls the welding system to selectively record motion such that recorded positioning data omits (i) initial transient motions and/or (ii) stop-start motions. Examples of how this may be accomplished have been described above and are thus not repeated here. Note that step 10-2 would generally be executed concurrently with step 10-1, although some editing of the recorded positioning data can occur after the welding at step 10-1 in some cases.

At step 10-3, the control circuitry controls the welding system to weld the metal sections together along the seam in a subsequent pass, in accordance with an automatic state. This is made possible by using the recorded positioning data from step 10-2. Examples of how this may be accomplished have been described above and are thus not repeated here.

Note that the initial transient motions and/or stop-start motions can be omitted by removing (e.g. overwriting) these motions from the recorded positioning data in the event that they were initially recorded, such that the motions are not present in the recorded positioning data that is utilized in the automatic state.

Note that step 10-3 can be repeated for additional subsequent passes until the welding is deemed to be complete at step 10-4.

### Computer Readable Medium

According to another embodiment of the disclosure, there is provided a non-transitory computer readable medium having recorded thereon statements and instructions that, when executed by control circuitry (e.g. the processor 107 of the system 10 shown in FIG. 3), implement a method as described herein, for example the method described above with reference to FIG. 10. There are many possibilities for the non-transitory computer readable medium. Some possibilities include an SSD (Solid State Drive), a hard disk drive, a CD (Compact Disc), a DVD (Digital Video Disc), a BD (Blu-ray Disc), a memory stick, or any appropriate combination thereof.

Numerous modifications and variations of the present disclosure are possible in light of the above teachings. It is therefore to be understood that within the scope of the appended claims, the disclosure may be practised otherwise than as specifically described herein.

We claim:

1. A system comprising:
a robotic welding apparatus configured to weld metal sections together along a seam;
an input device configured to produce positioning input for the robotic welding apparatus while welding; and
a controller configured to control the robotic welding apparatus in accordance with (i) a recording state in which operation of the robotic welding apparatus is controlled and recorded while welding in a root pass based on the positioning input to produce recorded positioning data, and (ii) an automatic state in which operation of the robotic welding apparatus is automatically controlled while welding in a subsequent pass based on the recorded positioning data;
wherein the controller is configured to selectively record motion of the robotic welding apparatus such that the recorded positioning data utilized in the automatic state omits at least one of (i) initial transient motions of the robotic welding apparatus and (ii) stop-start motions of the robotic welding apparatus.

2. The system of claim 1, wherein the metal sections comprise pipe sections that have been stitched together with stitches to form a pipe string, and the system further comprises:
a positioner configured to rotate the pipe string in relation to the robotic welding apparatus such that the robotic welding apparatus welds along the seam which is between the pipe sections;
wherein the root pass and the subsequent pass both involve rotating the pipe string in relation to the robotic welding apparatus by a full rotation.

3. The system of claim 1, wherein the recorded positioning data omits the initial transient motions of the robotic welding apparatus, and the controller is configured to omit the initial transient motions by not recording motions for an initial time period at a beginning of the root pass.

4. The system of claim 1, wherein the recorded positioning data omits the initial transient motions of the robotic welding apparatus, and the controller is configured to omit the initial transient motions by recording motions starting from a beginning of the root pass and removing recorded motions of the robotic welding apparatus during an initial time period at the beginning of the root pass.

5. The system of claim 1, wherein the recorded positioning data omits stop-start motions of the robotic welding apparatus, and the system is configured to omit start-stop motions by pausing recording when the robotic welding apparatus stops moving relative to the metal sections and resuming recording when the robotic welding apparatus starts moving relative to the metal sections.

6. The system of claim 1, wherein the recorded positioning data omits stop-start motions of the robotic welding apparatus and the stop-start motions are responsive to a welding mishap and involves repeat welding in a region of the welding mishap, and wherein the recorded positioning data omits motions of the robotic welding apparatus during the welding mishap.

7. The system of claim 6, wherein omitting motions of the robotic welding apparatus during the welding mishap involves removing recorded motions of the robotic welding apparatus during the welding mishap.

8. The system of claim 7, wherein omitting motions of the robotic welding apparatus during the welding mishap involves replacing the recorded motions of the robotic welding apparatus during the welding mishap with recorded motions during the repeat welding in the region of the welding mishap.

9. The system of claim 1, wherein the input device comprises a camera.

10. The system of claim 1, wherein the input device comprises a joystick device.

11. The system of claim 1, wherein the input device comprises a laser device.

12. The system of claim 1, wherein the controller comprises a PLC (programmable logic controller).

13. A method comprising:
welding, using a robotic welding apparatus, metal sections together along a seam in a root pass in accordance with a recording state in which operation of the robotic welding apparatus is controlled and recorded based on positioning input from an input device to produce recorded positioning data;
welding, using a robotic welding apparatus, the metal sections together along the seam in a subsequent pass in accordance with an automatic state in which operation of the robotic welding apparatus is automatically controlled based on the recorded positioning data;
wherein the method comprises selectively recording motion of the robotic welding apparatus such that the recorded positioning data utilized in the automatic state omits at least one of (i) initial transient motions of the robotic welding apparatus and (ii) stop-start motions of the robotic welding apparatus.

14. The method of claim 13, wherein the metal sections comprise pipe sections that have been stitched together with stitches to form a pipe string, and the method further comprises:
rotating the pipe string in relation to the robotic welding apparatus such that the robotic welding apparatus welds along the seam which is between the pipe sections;
wherein the root pass and the subsequent pass both involve rotating the pipe string in relation to the robotic welding apparatus by a full rotation.

15. The method of claim 13, wherein the recorded positioning data omits the initial transient motions of the robotic welding apparatus.

16. The method of claim 15, wherein the recorded positioning data omits the initial transient motions of the robotic welding apparatus by:
omitting the motions of the robotic welding apparatus for an initial time period at a beginning of the root pass.

17. The method of claim 16, wherein omitting motions of the robotic welding apparatus for the initial time period comprises:
removing recorded motions of the robotic welding apparatus during the initial time period.

18. The method of claim 13, wherein the recorded positioning data omits stop-start motions of the robotic welding apparatus.

19. The method of claim 18, wherein the stop-start motions are responsive to a welding mishap and involves repeat welding in a region of the welding mishap, and wherein the recorded positioning data omits motions of the robotic welding apparatus by:
omitting the motions of the robotic welding during the welding mishap of the root pass.

20. The method of claim 19, wherein omitting the motions of the robotic welding apparatus during the welding mishap comprises:
replacing recorded motions of the robotic welding apparatus leading up to the welding mishap with recorded motions of the robotic welding apparatus during the repeat welding.

21. A non-transitory computer readable medium having recorded thereon statements and instructions that, when executed by control circuitry of a welding system, configure the welding system to implement the method of claim 13.
